(19) United States
(12) Patent Application Publication
(10) Pub. No.: US 2026/0194095 A1
(43) Pub. Date: Jul. 9, 2026

(54) MONKEY BAR JOINER

(71) Applicant: FUNKY MONKEY BARS PTY LTD, Yangebup (AU)

(72) Inventors: Colin Derek Burdle, Yangebup (AU); Shane Bruce Roberts, Yangebup (AU)

(73) Assignee: FUNKY MONKEY BARS PTY LTD, Yangebup, WA (AU)

(21) Appl. No.: 18/868,733

(22) PCT Filed: May 23, 2023
(86) PCT No.: PCT/AU2023/050433

§ 371 Date: Nov. 23, 2024

(30) Foreign Application Priority Data
May 24, 2022 (AU) 2022901399

(51) Int. Cl. F16B 7/18; A63B 1/00

(52) U.S. Cl. CPC F16B 7/182; A63B 1/00; F16B 7/185

(57) ABSTRACT

A monkey bar joiner (10) comprising an elongate first body portion (12) defining an inner surface (14) and an opposed arcuate outer surface (16) having an intermediate shoulder (18), with at least one threaded aperture (20) defined from said outer (16) to inner (14) surfaces. Also included is an elongate second body portion (22) defining an inner surface (24) and an opposed arcuate outer surface (26) with a corresponding intermediate shoulder (28), the inner surface (24) forming an abutment (30). Joiner (10) also includes at least one threaded fastener 32 configured for operative threaded engagement within the at least one threaded aperture (20), wherein the body portions (12 and 22) are combinable so that the respective inner surfaces (14 and 24) complementarily abut and an end of a monkey bar 6 is receivable about the outer surfaces (16 and 26) to lie against the shoulders (18 and 28). The threaded fastener (32) is screwable to urge against the abutment 30 to urge the body portions (12 and 22) apart so that the respective arcuate outer surfaces (16 and 26) frictionally engage an inner surface of the monkey bar (6) to join two monkey bars in a continuous and substantially flush manner.

### TECHNICAL FIELD

This invention relates broadly to the field of playground equipment and monkey bars, and more specifically to a monkey bar joiner and an associated method of joining monkey bars.

### BACKGROUND ART

The following discussion of the background art is intended to facilitate an understanding of the present invention only. The discussion is not an acknowledgement or admission that any of the material referred to is or was part of the common general knowledge as at the priority date of the application.

Monkey bars, also called a jungle gym or a climbing frame, is known in the art and is generally a piece of playground and/or exercise equipment made of many pieces of material, such as metal pipe bars or beams, on which participants can climb, hang, sit, swing, slide etc. Such monkey bars may take a nearly infinite number of configurations depending on requirements. Monkey bar configurations may include platforms with ladders and railings around the outer edges, exercise equipment, climbing ropes, etc.

Applicant has developed free-standing monkey bars that generally do not require permanent installation necessitating foundation structures and related cementing into the ground. As a result of this development, monkey bars can be easily assembled by people without requiring prior knowledge or experience of monkey bars installation, which has democratised monkey bars particularly as an online orderable commodity. Accordingly, people wanting to provide entertainment to children, or to use monkey bars for physical fitness or training, are able to order a monkey bars installation which can be delivered by courier or postal delivery for do-it-yourself assembly.

However, while such democratisation of monkey bars is popular, it does have logistical shortcomings regarding delivery of monkey bar parts via delivery services, such as postal or courier services. Constituent parts of a monkey bar installation can generally be flat-packed for shipping; however longer bars inherently take up more space and introduce handling issues for delivery services.

The current invention was conceived with these shortcomings in mind in an attempt to ameliorate delivery of online-orderable monkey bar installations for self-assembly.

### SUMMARY OF THE INVENTION

The skilled addressee is to appreciate that reference herein to a ‘monkey bar’ generally refers to a generally elongate pipe, typically tubular, forming part of a monkey bar installation or frame. Such monkey bar is typically manufactured from metal via a suitable extrusion and/or drawing process, as known in the art, to produce a monkey bar. Typically, such a monkey bar also includes an internal longitudinal ridge as remnant of a manufacturing process.

According to a first aspect of the invention there is provided a monkey bar joiner comprising:
An elongate first body portion defining an inner surface and an opposed arcuate outer surface having an intermediate shoulder, at least one threaded aperture defined from said outer to inner surfaces;
an elongate second body portion defining an inner surface and an opposed arcuate outer surface with a corresponding intermediate shoulder, the inner surface forming an abutment; and
at least one threaded fastener configured for operative threaded engagement within the at least one threaded aperture; wherein the body portions are combinable so that the respective inner surfaces complementarily abut and an end of a monkey bar is receivable about the outer surfaces to lie against the shoulders, the threaded fastener screwable to urge against the abutment to urge the body portions apart so that the respective arcuate outer surfaces frictionally engage an inner surface of the monkey bar to join two monkey bars in a continuous and substantially flush manner.

In an embodiment, the first body portion defines a threaded aperture on either end with a further threaded aperture defined on the intermediate shoulder, with the second body portion defining corresponding abutments.

Typically, each end of the monkey bars defines an access aperture to allow access to a threaded fastener at an end of the body portion.

In an embodiment, the body portions are configured so that the intermediate shoulders correspond with a wall thickness of the monkey bars to facilitate flush joining of said monkey bars.

In an embodiment, the intermediate shoulders each defines an indentation which complementarily forms a slot when the body portions are combined, said slot configured to receive and capture an accessory when the monkey bars are joined.

Typically, the accessory comprises a mounting for a monkey bar installation.

In an embodiment, the outer surfaces of the body portions are configured to align with an internal longitudinal ridge of the monkey bars to counteract rotation of said monkey bars when joined by the joiner.

Typically, the at least one threaded fastener is shaped and dimensioned to lie flush with the joiner and/or monkey bars when the monkey bars are joined.

Typically, an area of the arcuate outer surface is selectable according to a joining strength required from the joiner.

In an embodiment, the outer surface is knurled to facilitate frictional engagement with the inner surface of the monkey bars.

According to a second aspect of the invention there is provided a method of joining monkey bars, said method comprising the steps of:
providing a monkey bar joiner in accordance with the first aspect of the invention;
combining body portions of the joiner and placing ends of two monkey bars over respective ends of said joiner to lie against the shoulders; and
screwing at least one threaded fastener to urge said body portions apart to frictionally engage inner surfaces of the monkey bars to join said monkey bars in a continuous and substantially flush manner.

In an embodiment, the method includes capturing a monkey bars accessory within a slot defined by the intermediate shoulders when combining the body portions.

In an embodiment, the method includes aligning the outer surfaces of the body portions with an internal longitudinal ridge of the monkey bars to counteract rotation of said monkey bars when joined by the joiner.

According to a third aspect of the invention there is provided a monkey bar joiner comprising:
an elongate first body portion defining an inner surface and an opposed arcuate outer surface with at least two threaded apertures defined from said outer to inner surfaces;
an elongate second body portion defining an inner surface and an opposed arcuate outer surface, the inner surface forming an abutment; and
at least two threaded fasteners each configured for operative threaded engagement within a threaded aperture; wherein the body portions are combinable so that the respective inner surfaces complementarily abut and ends of respective monkey bars are receivable about the outer surfaces, the threaded fasteners passable through complementary access apertures defined in said respective monkey bar ends and screwable to urge against the abutment to urge the body portions apart so that the respective arcuate outer surfaces frictionally engage inner surfaces of the monkey bars to join said monkey bars in a continuous and substantially flush manner.

In an embodiment, the first body portion defines a threaded aperture on either end with the second body portion defining corresponding abutments.

In an embodiment, the outer surfaces of the body portions are configured to align with an internal longitudinal ridge of the monkey bars to counteract rotation of said monkey bars when joined by the joiner.

Typically, the at least one threaded fastener is shaped and dimensioned to lie flush with the joiner and/or monkey bars when the monkey bars are joined.

Typically, an area of the arcuate outer surface is selectable according to a joining strength required from the joiner.

In an embodiment, the outer surface is knurled to facilitate frictional engagement with the inner surface of the monkey bars.

According to a fourth aspect of the invention there is provided a method of joining monkey bars, said method comprising the steps of:
providing a monkey bar joiner in accordance with the third aspect of the invention;
combining body portions of the joiner and placing ends of two monkey bars over respective ends of said joiner; and
screwing at least two threaded fasteners to urge said body portions apart to frictionally engage inner surfaces of the monkey bars to join said monkey bars in a continuous and substantially flush manner.

In an embodiment, the method includes aligning the outer surfaces of the body portions with an internal longitudinal ridge of the monkey bars to counteract rotation of said monkey bars when joined by the joiner.

According to a further aspect of the invention there is provided a monkey bar joiner and an associated method of joining monkey bars, substantially as herein described and/or illustrated.

### BRIEF DESCRIPTION OF THE DRAWINGS

The description will be made with reference to the accompanying drawings in which:

FIG. 1 is a diagrammatic perspective overview representation of a monkey bar joiner, in accordance with aspects of the present invention;

FIG. 2 is a diagrammatic perspective view representation of the monkey bar joiner of FIG. 1, in use;

FIG. 3 is diagrammatic exploded view representation of the monkey bar joiner of FIG. 1;

FIG. 4 is a diagrammatic side-sectional representation of the monkey bar joiner of FIG. 1, showing joining of monkey bars as described herein;

FIG. 5 is a diagrammatic exploded view representation of the monkey bar joiner of FIG. 1 showing monkey bars to be joined thereby;

FIG. 6 is a diagrammatic side-sectional representation of the monkey bar joiner of FIG. 1 operatively joining monkey bars;

FIG. 7 is a diagrammatic perspective overview representation of a monkey bar joiner, in accordance with an aspect of the present invention;

FIG. 8 is a diagrammatic perspective view representation of the monkey bar joiner of FIG. 7, in use;

FIG. 9 is diagrammatic exploded view representation of the monkey bar joiner of FIG. 7;

FIG. 10 is a diagrammatic exploded view representation of the monkey bar joiner of FIG. 7 showing monkey bars to be joined thereby;

FIG. 11 is a diagrammatic side-sectional representation of the monkey bar joiner of FIG. 7, showing joining of monkey bars as described herein;

FIG. 12 is a diagrammatic perspective view representation of a monkey bar joiner showing a knurled or otherwise configured outer surface to facilitate engagement with monkey bars; and

FIG. 13a and b show diagrammatic perspective overview representation of parts of a monkey bar joiner, in accordance with an aspect of the present invention.

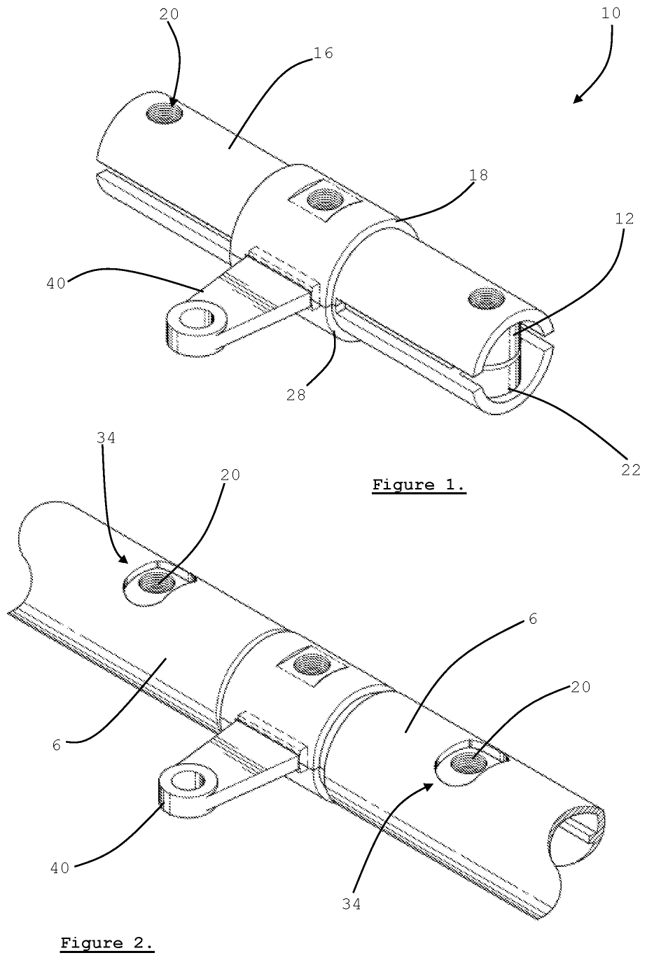

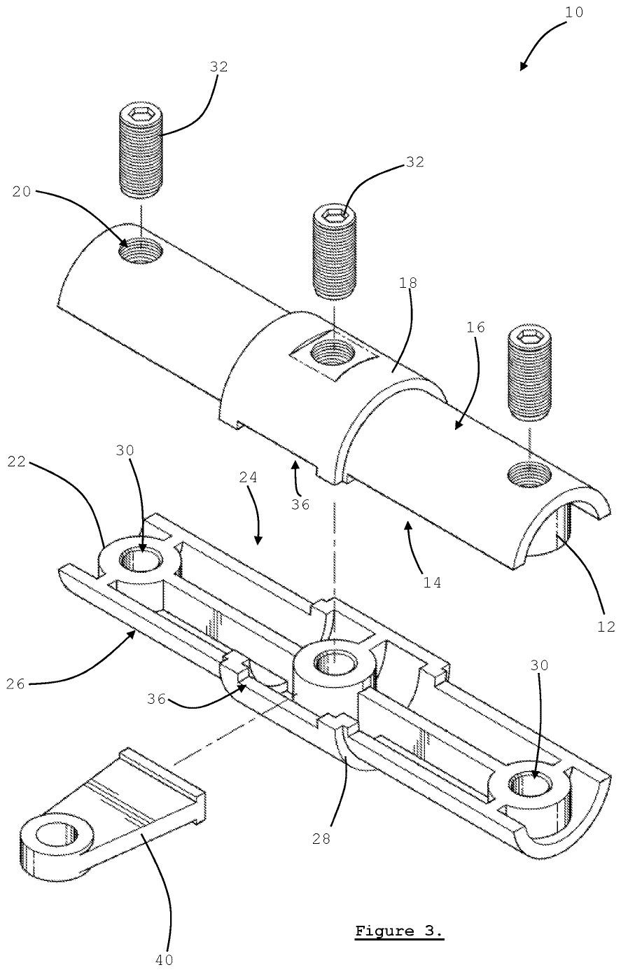

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

The present invention provides for a monkey bar joiner 10 which was developed specifically to allow joining of monkey bars 6 in a manner which is strong as well as aesthetic so that monkey bars 6 can be joined in a flush and continuous manner which does not present any unwanted external protuberances or projections that may present a safety risk to users of a monkey bars installation.

As described above, a typical monkey bar 6 generally comprises an elongate pipe, typically tubular, which forms part of a monkey bar installation or frame. Such a monkey bar is typically manufactured from metal via a suitable extrusion and/or drawing process, as known in the art, to produce a monkey bar. Typically, such a monkey bar 6 also includes an internal longitudinal ridge 8 as remnant of a manufacturing process.

With reference now to the accompanying figures, there is shown one broad embodiment of such a monkey bar joiner 10. Monkey bar joiner 10 generally comprises first and second body portions 12 and 22, along with at least one threaded fastener 32. An accessory 40 may be optional.

The first body portion 12 comprises an elongate body portion which defines an inner surface 14 and an opposed arcuate outer surface 16, as shown. The first body portion 12 also includes an intermediate shoulder 18, as well as at least one threaded aperture 20 which is defined from said outer to inner surfaces 16 to 14, i.e. the threaded aperture 20 runs through the body portion 12.

In a typical embodiment, the first body portion 12 defines a threaded aperture 20 on either end with a further threaded aperture defined on the intermediate shoulder 18, as shown, for a total of three threaded apertures 20 spaced along a length of the first body portion 12.

Similarly, the second body portion 22 is also an elongate second body portion which defines an inner surface 24 and an opposed arcuate outer surface 26 with a corresponding intermediate shoulder 28, as shown. In contrast with the first body portion 12, the second body portion defines abutments 30 on the inner surface 24 thereof. These abutments 30 generally corresponds with the threaded apertures 20 of the first body portion 12.

The monkey bar joiner 10 also includes at least one threaded fastener 32 which is configured for operative threaded engagement within the at least one threaded aperture 20 of the first body portion 12.

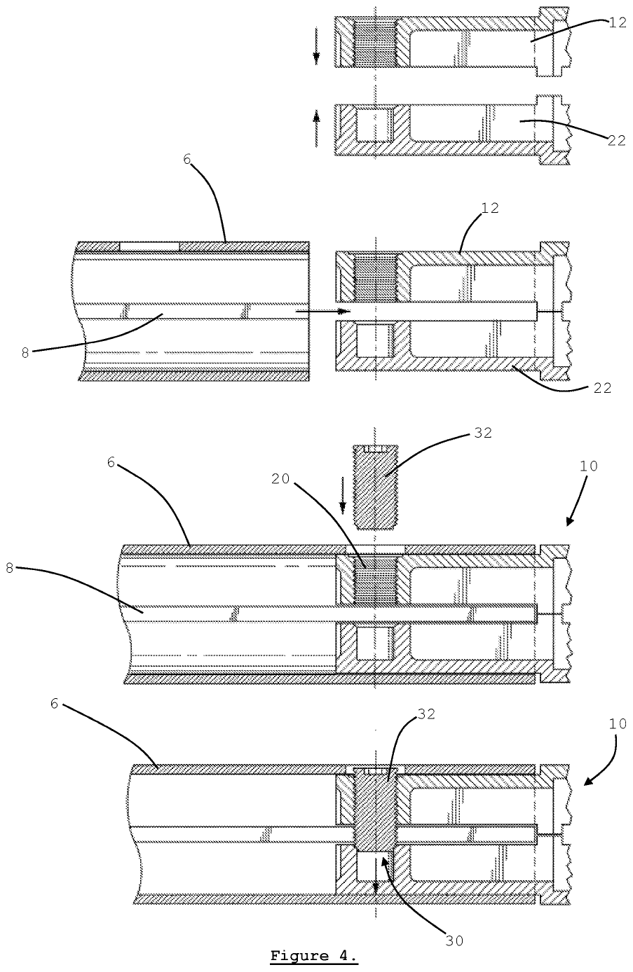

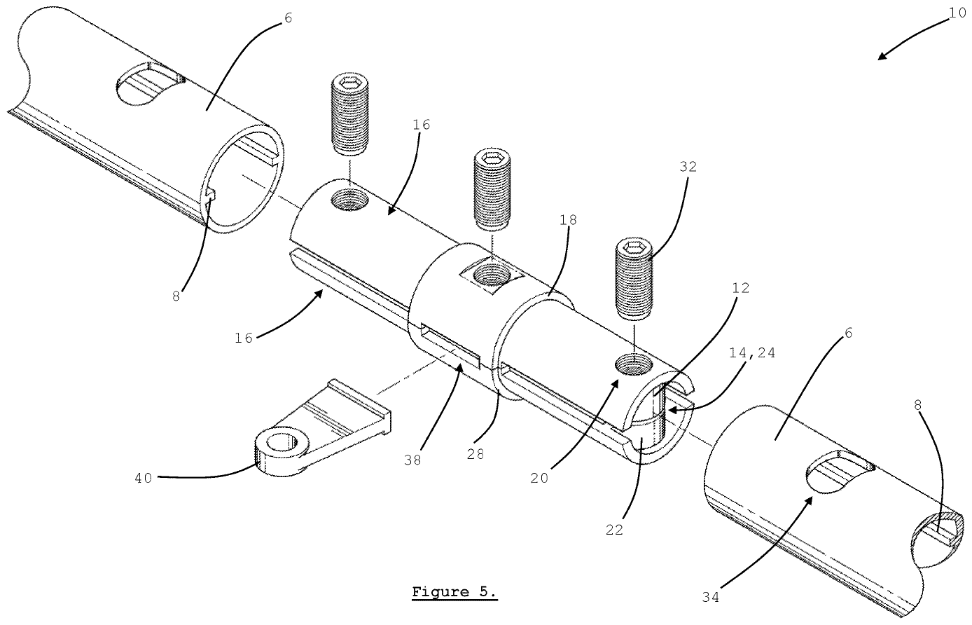

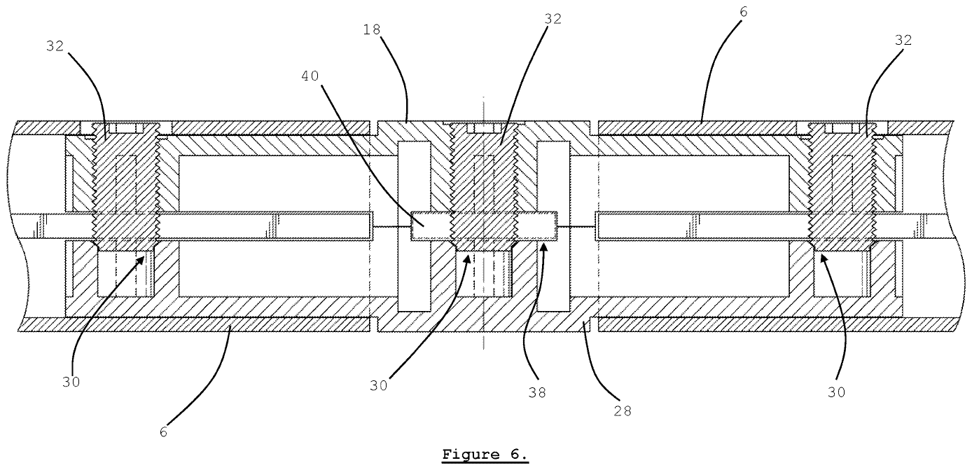

In this manner, the body portions 12 and 22 are combinable so that the respective inner surfaces 14 and 24 complementarily abut or lie against each other. An end of a monkey bar 6 is then receivable about or over the outer surfaces 16 and 26 so that the monkey bar 6 lies against the shoulders 18 and 28, as shown more clearly in FIG. 4. Typically, the body portions 12 and 22 are configured so that the intermediate shoulders 18 and 28 correspond with a wall thickness of the monkey bars 6 to facilitate flush joining of said monkey bars, i.e. a height of the shoulders 18 and 28 are the same as the wall thickness of the monkey bar 6, so that the shoulders 18 and 28 lie flush with the monkey bars 6 when joined by the joiner 10.

When the body portions 12 and 22 are combined with monkey bars 6 fitted over the ends thereof, as shown, the threaded fastener(s) 32 is screwable into the threaded aperture(s) 20 to urge against the respective abutment(s) 30 to urge the body portions 12 and 22 apart so that the respective arcuate outer surfaces 16 and 26 frictionally engage an inner surface of each monkey bar 6 to join the two monkey bars 6 in a continuous and substantially flush manner, i.e. the monkey bars 6 and joiner 10 form a continuous and smooth outer surface due to shoulders 18 and 28.

As shown, each end of the monkey bars 6 typically defines an access aperture 34 to allow access to a threaded fastener at an end of the body portion. This allows the threaded fasteners to lie flush or below an outer surface of such a join when fastened. Typically, the at least one threaded fastener 32 is shaped and dimensioned to lie flush with the joiner 10 and/or monkey bars 6 when the monkey bars are joined.

In an embodiment, the intermediate shoulders 18 and 28 each defines an indentation 36 which complementarily forms a slot 38 when the body portions 12 and 22 are combined, said slot 35 configured to receive and capture an accessory 40 when the monkey bars 6 are joined. Typically, the accessory 40 comprises a mounting for a monkey bar installation, such as a mounting for a rope, a strut, an exercise means, etc.

Additionally, in an embodiment, the outer surfaces 16 and 26 of the body portions 12 and 22 are configured to align with an internal longitudinal ridge 8 of the monkey bars 6 to counteract rotation of said monkey bars 6 when joined by the joiner 10. As described, such an internal longitudinal ridge 8 is often a remnant of a manufacturing process.

The skilled addressee is to appreciate that an area of the arcuate outer surface 16 and 26 is typically selectable during a manufacturing process of the joiner 10 according to a required joining strength required from the joiner 10. In an embodiment, the outer surfaces 16 and 26 may also be knurled or similarly irregular to facilitate frictional engagement with the inner surface of the monkey bars 6.

The skilled addressee is also to appreciate that the present invention further provides for an associated method of joining monkey bars 6. As shown sequentially in FIG. 4, such a method broadly comprises steps of providing a monkey bar joiner 10, as described, combining the body portions 12 and 22 of the joiner 10 and placing ends of two monkey bars 6 over respective ends of said joiner 10 to lie against the shoulders 18 and 28, and screwing the at least one threaded fastener 32 to urge said body portions 12 and 22 apart to frictionally engage inner surfaces of the monkey bars 6 to join said monkey bars in a continuous and substantially flush manner.

In an embodiment, such a method may also include capturing the monkey bars accessory 40 within the slot 38 defined by the intermediate shoulders 18 and 28 when combining the body portions 12 and 22. The method may also include aligning the outer surfaces 16 and 26 of the body portions 12 and 22 with an internal longitudinal ridge 8 of the monkey bars 6 to counteract rotation of said monkey bars 6 when joined by the joiner 10.

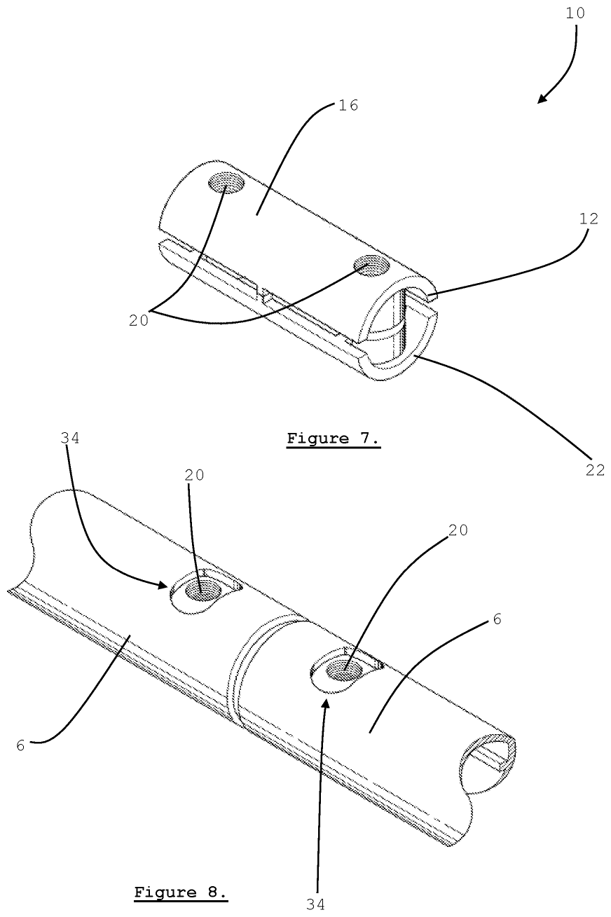

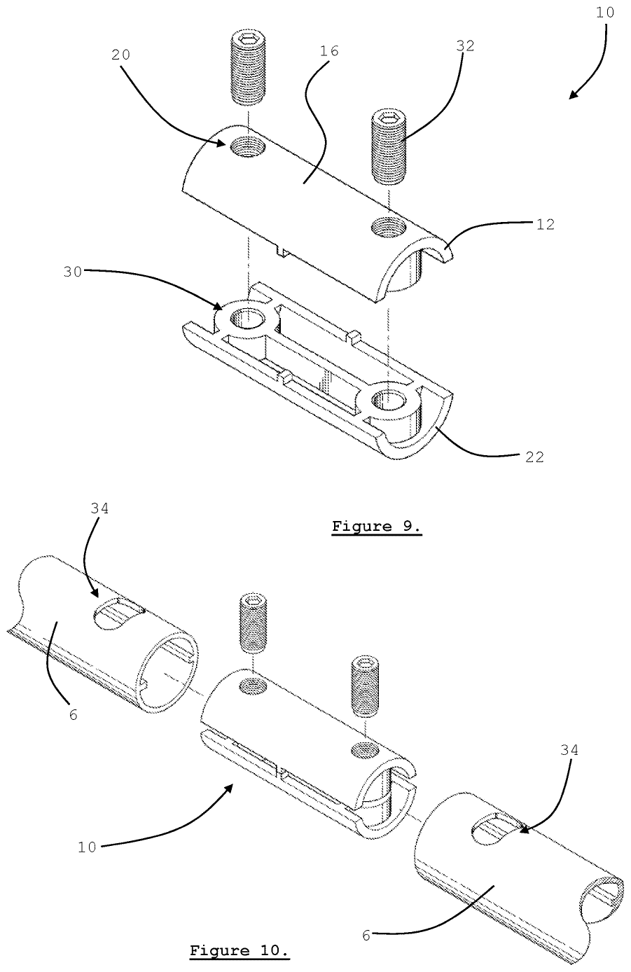

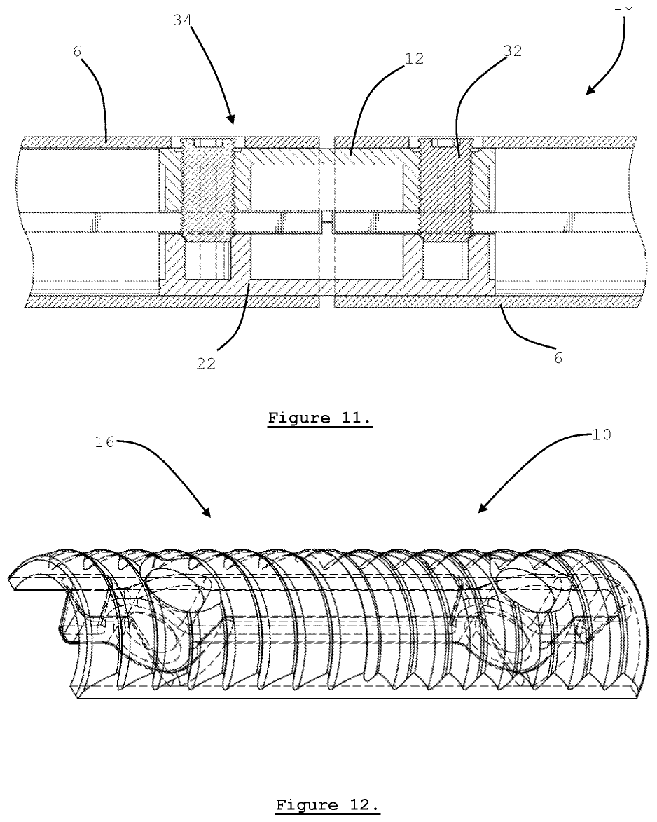

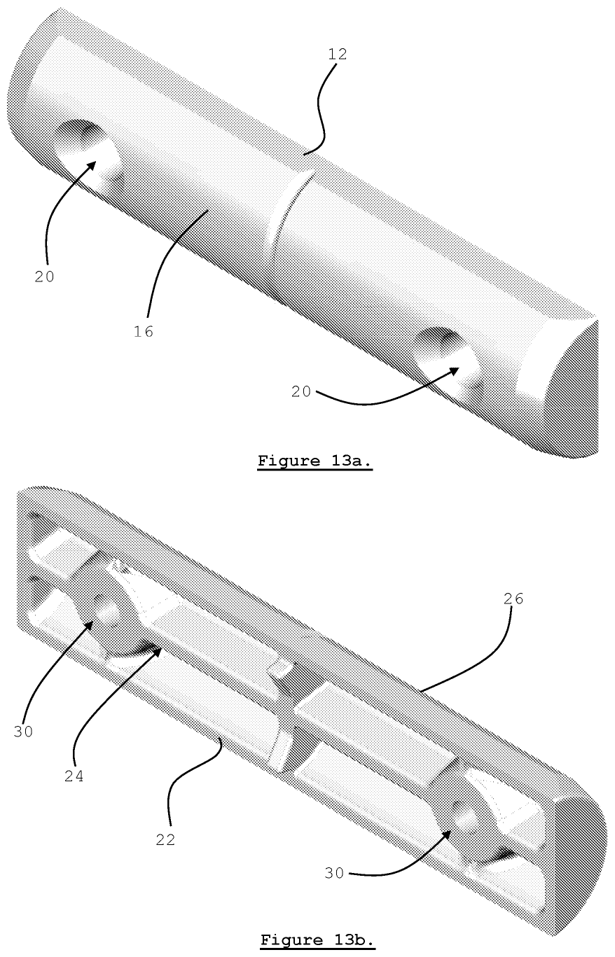

With reference now to FIGS. 7 to 13 of the accompanying drawings, there is shown a further embodiment of a monkey bar joiner 10 according to aspects of the present invention. Such a joiner 10 provides similar functionality as the above-described joiner, but does away with the intermediate shoulders 18 and 28 and accessory slot 38.

As shown, such an embodiment of the monkey bar joiner 10 generally comprises an elongate first body portion 12 defining an inner surface 14 and an opposed arcuate outer surface 16 with at least two threaded apertures 20 defined from said outer to inner surfaces 16 to 14. An elongate second body portion 22 is also included which defines an inner surface 24 and an opposed arcuate outer surface 26, with the inner surface also forming an abutment 30.

In this embodiment, at least two threaded fasteners 32 are each configured for operative threaded engagement within a threaded aperture 20. In this manner, the body portions 12 and 22 are combinable so that the respective inner surfaces complementarily abut and ends of respective monkey bars 6 are receivable about the outer surfaces, the threaded fasteners passable through complementary access apertures 34 defined in said respective monkey bar ends and screwable to urge against the abutment to urge the body portions 12 and 22 apart so that the respective arcuate outer surfaces frictionally engage inner surfaces of the monkey bars to join said monkey bars in a continuous and substantially flush manner.

In an embodiment, the first body portion 12 defines a threaded aperture 20 on either end with the second body portion defining corresponding abutments 30, as shown. In an embodiment, the outer surfaces the body portions are configured to align with an internal longitudinal ridge of the monkey bars to counteract rotation of said monkey bars when joined by the joiner. In an embodiment, an example of which is shown in FIG. 12, the outer surfaces are knurled or otherwise configured to facilitate frictional engagement with the inner surface of the monkey bars.

Typically, the at least one threaded fastener is shaped and dimensioned to lie flush with the joiner and/or monkey bars when the monkey bars are joined. Typically, an area of the arcuate outer surface is selectable according to a joining strength required from the joiner.

The present invention also provides for an accompanying method of joining monkey bars, said method comprising the steps of providing a monkey bar joiner 10 as exemplified in FIGS. 7 to 12, combining the body portions of the joiner and placing ends of two monkey bars over respective ends of said joiner, and screwing at least two threaded fasteners to urge said body portions apart to frictionally engage inner surfaces of the monkey bars to join said monkey bars in a continuous and substantially flush manner.

In an embodiment, the method includes aligning the outer surfaces of the body portions with an internal longitudinal ridge of the monkey bars to counteract rotation of said monkey bars when joined by the joiner.

Applicant believes it particularly advantageous that the present invention provides for a joiner 10 via which monkey bars 6 can be joined in a strong and continuous manner, i.e. to provide a flush outer surface after being joined. Joiner 10 also enables an accessory to be securely captured as part of the join. Joiner 10 further caters for existing monkey bar manufacturing processes by being able to capture an internal ridge of the monkey bars as part of the joiner's operation in order to counteract rotation of bars 6 when joined.

In particular, joiner 10 finds particular application in reducing bar lengths of ‘do-it-yourself’ monkey bar installations which are provided by delivery services for self-assembly, such as via postal and courier services. Such reduction in bar lengths facilitates packaging and delivery of monkey bar installations, especially those offered as online orderable monkey bar installations. This improvement in packaging requirements improves logistics and associated delivery costs.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to, ”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A monkey bar joiner comprising:
an elongate first body portion defining an inner surface and an opposed arcuate outer surface having an intermediate shoulder, at least one threaded aperture defined from said outer to inner surfaces;
an elongate second body portion defining an inner surface and an opposed arcuate outer surface with a corresponding intermediate shoulder, the inner surface forming an abutment; and
at least one threaded fastener configured for operative threaded engagement within the at least one threaded aperture;
wherein the body portions are combinable so that the respective inner surfaces complementarily abut and an end of a monkey bar is receivable about the outer surfaces to lie against the shoulders, the threaded fastener screwable to urge against the abutment to urge the body portions apart so that the respective arcuate outer surfaces frictionally engage an inner surface of the monkey bar to join two monkey bars in a continuous and substantially flush manner.

2. The monkey bar joiner of claim 1, wherein the first body portion defines a threaded aperture on either end with a further threaded aperture defined on the intermediate shoulder, with the second body portion defining corresponding abutments.

3. The monkey bar joiner of claim 1, wherein each end of the monkey bars defines an access aperture to allow access to a threaded fastener at an end of the body portion.

4. The monkey bar joiner of claim 1, wherein the body portions are configured so that the intermediate shoulders correspond with a wall thickness of the monkey bars to facilitate flush joining of said monkey bars.

5. The monkey bar joiner of claim 1, wherein the intermediate shoulders each defines an indentation which complementarily forms a slot when the body portions are combined, said slot configured to receive and capture an accessory when the monkey bars are joined.

6. The monkey bar joiner of claim 1, wherein the accessory comprises a mounting for a monkey bar installation.

7. The monkey bar joiner of any of claim 1, wherein the outer surfaces of the body portions are configured to align with an internal longitudinal ridge of the monkey bars to counteract rotation of said monkey bars when joined by the joiner.

8. The monkey bar joiner of any of claim 1, wherein the at least one threaded fastener is shaped and dimensioned to lie flush with the joiner and/or monkey bars when the monkey bars are joined.

9. The monkey bar joiner of claim 1, wherein an area of the arcuate outer surface is selectable according to a joining strength required from the joiner.

10. The monkey bar joiner of claim 1, wherein the outer surface is knurled to facilitate frictional engagement with the inner surface of the monkey bars.

11. A method of joining monkey bars, said method comprising the steps of:
providing a monkey bar joiner in accordance with claim 1;
combining body portions of the joiner and placing ends of two monkey bars over respective ends of said joiner to lie against the shoulders; and
screwing at least one threaded fastener to urge said body portions apart to frictionally engage inner surfaces of the monkey bars to join said monkey bars in a continuous and substantially flush manner.

12. The method of claim 11, which includes capturing a monkey bars accessory within a slot defined by the intermediate shoulders when combining the body portions.

13. The method of claim 11, which includes aligning the outer surfaces of the body portions with an internal longitudinal ridge of the monkey bars to counteract rotation of said monkey bars when joined by the joiner.

14. A monkey bar joiner comprising:
an elongate first body portion defining an inner surface and an opposed arcuate outer surface with at least two threaded apertures defined from said outer to inner surfaces;
an elongate second body portion defining an inner surface and an opposed arcuate outer surface, the inner surface forming an abutment; and
at least two threaded fasteners each configured for operative threaded engagement within a threaded aperture;
wherein the body portions are combinable so that the respective inner surfaces complementarily abut and ends of respective monkey bars are receivable about the outer surfaces, the threaded fasteners passable through complementary access apertures defined in said respective monkey bar ends and screwable to urge against the abutment to urge the body portions apart so that the respective arcuate outer surfaces frictionally engage inner surfaces of the monkey bars to join said monkey bars in a continuous and substantially flush manner.

15. The monkey bar joiner of claim 14, wherein the first body portion defines a threaded aperture on either end with the second body portion defining corresponding abutments.

16. The monkey bar joiner of claim 14, wherein the outer surfaces of the body portions are configured to align with an internal longitudinal ridge of the monkey bars to counteract rotation of said monkey bars when joined by the joiner.

17. The monkey bar joiner of claim 14, wherein the at least one threaded fastener is shaped and dimensioned to lie flush with the joiner and/or monkey bars when the monkey bars are joined.

18. The monkey bar joiner of claim 14, wherein an area of the arcuate outer surface is selectable according to a joining strength required from the joiner.

19. The monkey bar joiner of claim 14, wherein the outer surface is knurled to facilitate frictional engagement with the inner surface of the monkey bars.

20. A method of joining monkey bars, said method comprising the steps of:
providing a monkey bar joiner in accordance with claim 14;
combining body portions of the joiner and placing ends of two monkey bars over respective ends of said joiner; and
screwing at least two threaded fasteners to urge said body portions apart to frictionally engage inner surfaces of the monkey bars to join said monkey bars in a continuous and substantially flush manner.

21. (canceled)
